(19) United States
(12) Patent Application Publication
(10) Pub. No.: US 2007/0148488 A1
(43) Pub. Date: Jun. 28, 2007

(54) Flat bar strip and metal profile part

(76) Inventor: Andreas Gutermuth, Angelburg (DE)

Correspondence Address: CHARLES P. BOUKUS ,JR;SUITE 202, 2001 JEFFERSON DAVIS HIGHWAY, ARLINGTON, VA, 22202, US

(21) Appl. No.: 11/640,342

(22) Filed: Dec. 18, 2006

(30) Foreign Application Priority Data
Dec. 22, 2005 (DE) 10 2005 062 063.9

(51) Int. Cl. C22C 38/00; B32B 15/00

(52) U.S. Cl. 428/592; 148/320; 428/603; 428/615

(57) ABSTRACT

The present invention relates to a metal strip, which can be wound up into a coil (1; 14) and which has at least two joined-together portions (2, 3; 4, 5, 6); these portions (2, 3; 4, 5, 6) are joined together, adjacent one another, substantially in the transverse direction of the metal strip (1; 14). The invention also relates to a production process for creating profile parts (7; 10), using the metal strip (1; 14) that has different portions (2, 3; 4, 5, 6) in the longitudinal direction.

### FIELD OF THE INVENTION

The invention relates to a metal strip as well as profile parts to be made from it, in which the metal strip is intended to be wound up into a coil and has at least two joined-together portions.

### BACKGROUND OF THE INVENTION

In the prior art, a so-called tailored coil is known, as a prefabricated starting material for profile and molding parts for the vehicle and profile industry, for instance. In the production of a tailored coil, two or more metal strips of different materials, and in particular different types of steel, which themselves are usually in the form of a coil, are welded together longitudinally. Particularly for the sake of more economical storage and further processing, the metal strip welded in the longitudinal direction is wound up into a coil known as a tailored coil.

Because of the portions, comprising different materials, that adjoin one another in the longitudinal direction of the metal strip to be wound up, the configuration and quality of a product to be made from such a tailored coil is in a certain sense predetermined. For instance, if profile parts whose longitudinal direction coincides with the longitudinal direction of the metal strip are to be made from a tailored coil, then different materials and/or material properties can be implemented only in the transverse direction of the profile to be produced.

Furthermore, for instance from German Patent Disclosure DE 10 2004 023 887 A1, so-called flexible rolling of strip material is known, by which material thicknesses in the strip material that vary periodically in the longitudinal direction can be created. A period length of the rolled longitudinal thickness profile is essentially equivalent to the length of a single part to be made from the strip material and is equivalent in its material thickness to the later load profile of that component. The sheet-metal thickness profiles created in the longitudinal direction as the strip material is rolled represent blanks in the strip that are lined up continuously one against the other.

After the rolling process, the strip is wound up into the coil, and finally, for cutting apart blanks and further processing them into shaped sheet-metal parts, the strip is unwound from the coil again, cut apart into individual blanks, and delivered to suitable presses, so as to obtain a completely cut and drawn or pressed shaped sheet-metal part with varying wall thicknesses in the longitudinal direction. Problem By means of so-called flexible rolling, metal strips with different sheet-metal thicknesses and profiles in the longitudinal direction can indeed be created. However, adapting the strip material, which can be created in flexible rolling, to the later load profile of a component to be made from it, can be attained, with flexible rolling, only by way of the variable material thickness. For instance, if one region of a shaped sheet-metal part that can be made from the metal strip is intended to have greater strength, this can be achieved by the method of flexible rolling only by increasing the material cross section in this region, yet this unavoidably means an increase in weight, which is considered disadvantageous.

To create metal strips which can be wound up into a coil and which have arbitrarily dimensioned and arbitrarily disposed portions, neither flexible rolling nor the use of conventional tailored coils with band portions extending in the longitudinal direction is suitable. While metal strips of conventional tailored coils always have varying materials or material properties in the transverse direction, in flexible rolling, sheet-metal thickness profiles that vary in the longitudinal direction can be created only from a single material.

### SUMMARY OF THE INVENTION

It is therefore the object of the present invention to make a metal strip available which in a more versatile, universal and flexible way can match a later load profile of a component to be made from the metal strip.

The problem on which the invention is based is attained by means of a metal strip as defined by claim 1, a method as defined by claim 14, and a profile part as defined by claim 19. Further advantageous features of the invention are defined by the respective dependent claims.

The metal strip of the invention is intended to be wound up into a coil and has at least two joined-together portions, which are joined together adjacent one another essentially in the transverse direction of the strip. The adjacent regions of the joined-together portions extend here essentially in the transverse direction of the metal strip. Thus in the longitudinal direction of the metal strip, different joined-together portions are provided. The metal strip can therefore have different material properties and qualities in the longitudinal direction, depending on the quality of the joined-together portions, especially with regard to strength, geometry, surface quality, and the like, to suit the demands made of a component to made from the metal strip.

In a first advantageous embodiment of the invention, the at least two joined-together portions, joined together adjacent one another in the transverse direction of the metal strip comprise different materials or types of materials. Thus different types of materials can be joined together in the longitudinal direction of the metal strip to suit the load profile of the component, so that predetermined load requirements with respect to the longitudinal direction of the component can be met not only by means of a change in the material thickness as known from flexible rolling but also, according to the invention, by means of different materials and types of materials.

In this respect it is provided in particular that the joined-together portions of the metal strip comprise steel or aluminum or alloys having steel and/or aluminum components.

In a further advantageous embodiment, the at least two portions of the metal strip have different material thicknesses. In this way, predetermined load profiles of a component to be produced can be created both by using different materials of substantially the same material thickness and identical materials of different material thickness, but flexible rolling of the metal strip can advantageously be dispensed with.

Creating strip material with a material thickness that varies in the longitudinal direction can be done according to the invention by joining together individual portions of different material thickness.

Naturally, a combination and the joining together of portions of different materials and different material thicknesses is furthermore readily possible as well, so that predetermined load requirements of the component to be made can be attained variably and flexibly by the choice of different material thicknesses and/or of different materials or types of materials. With the metal strip of the invention, it is thus possible to react substantially more flexibly, variably and universally to load profiles and load requirements of the formed sheet-metal parts to be made. This results above all in savings in weight and material and thus also in cost for a production process for profile parts or shaped parts that can be made from metal strip.

It is also provided that the width of the at least two portions of the metal strip is essentially equivalent/to the transverse extent of the strip. The metal strip of the invention can therefore have a constant quality in the transverse direction.

In a further embodiment, it is provided that the length of the at least two portions of the metal strip is greater than their width. In such an embodiment, it is advantageous in particular that the total length of seams, extending in the transverse direction, of the joined-together portions can be kept shorter than the longitudinal extent of the metal strip. If the metal strip is joined together by means of a thermal joining process, for instance, less production cost, especially with regard to the length of a joining seam, is therefore necessary compared with conventional tailored coils joined together longitudinally.

It is moreover advantageous that the at least two portions of the metal strip are disposed periodically in the longitudinal direction of the strip. A periodically repeating order of disposition in the longitudinal direction of the metal strip is advantageous above all for producing components with predetermined load requirements, whose length is substantially equivalent to the period length of the metal strip. Hence the longitudinally oriented disposition of the adjacent joined-together portions is advantageous in the sense that an endless strip material can be subjected to a shaping process before individual components, corresponding to the periodicity of the metal strip, can be cut to length from the formed and preferably profiled metal strip.

It is also provided for the invention that the at least two portions are butt-jointed and/or are joined together by means of a thermal joining process.

Preferably, the at least two portions of the metal strip are welded together, and various welding methods, especially laser welding, can be employed for joining the portions together.

It is also provided that a joining seam extends substantially continuously between the at least two portions of the metal strip, between the two side edges of the metal strip.

It is advantageous in this respect that the seam between the at least two portions extends in at least some regions rectilinearly and/or is curved and/or is bent. In this way, the various joined-together portions of the metal strip can have virtually any two-dimensional geometry.

Preferably, the individual joined-together portions of the metal strip have a rectangular or platelike geometry. Other arbitrary geometries are conceivable, in particular such as portion boundaries extending obliquely to the transverse direction or longitudinal direction of the metal strip, or convex or curved courses of connecting seams of the joined-together portions, or courses that are bent arbitrarily in other ways.

In a further feature of the metal strip, the at least two portions have an arbitrary geometry that together completely fill the strip.

In a further advantageous feature of the invention, an at least third portion is provided, which is joined to at least one of the at least two portions adjacent one another, in at least some regions essentially in the longitudinal direction and in the transverse direction of the strip. In this embodiment, portions in the strip may also be provided that do not extend over the full width of the metal strip for completely filling the surface area of the strip, such portions are joined, adjacent one another, together with a further portion essentially in the longitudinal direction of the metal strip. This creates a kind of patchwork pattern of arbitrarily designed portions dimensioned to suit the requirements, the portions being joined together adjacent one another in both the longitudinal direction and the transverse direction.

In a further independent aspect, the invention relates to a method for producing profiles or profile parts, particularly for vehicle bodies, which is distinguished by an at least regional shaping of the metal strip of the invention. The shaping is contemplated here preferably in the transverse direction of the metal strip, so that the longitudinal direction of the profile to be made by the method of the invention substantially matches the longitudinal direction of the metal strip.

Because of the fact that in the longitudinal direction, the metal strip has portions comprising different materials, types of material, or material qualities, it is thus advantageously possible in a simple way to achieve profiles which in the longitudinal direction have different materials and/or types of material and/or material qualities, such as the material thickness.

In a first advantageous embodiment of the production method, the at least regional shaping of the metal strip is accomplished by means of roller profiling and/or deep drawing and/or stretcher-forming. In particular, roller profiling of the metal strip is contemplated for shaping of a metal strip that can be unwound from a coil.

The production of the metal strip itself, or in other words joining together individual portions of the metal strip and then shaping them into a profiled metal strip, can advantageously be combined in one production line. In such an embodiment, in which the production and further processing of the metal strip of the invention are done in the same production line, winding up the metal strip into a coil can advantageously be dispensed with.

In other embodiments of the production method for the profile parts, however, it is provided that the metal strip is delivered in the form of a wound-up coil to a shaping process and a corresponding shaping apparatus. With regard to storage and shipping of the metal strip, winding the metal strip up into a coil is advantageous. The metal strip, as an intermediate product, can thus be especially efficiently produced and further processed even at different locations, which in particular makes flexible, versatile usage of the metal strip possible.

In a further embodiment, it is provided that the metal strip, shaped for instance by roller profiling, is cut to length to suit the periodicity of the portions joined to one another in the longitudinal direction of the strip. Thus in the final analysis, individual profile parts of a predetermined length are created, with different materials, types of material or otherwise different material qualities in the longitudinal direction. The advantage of this production method for profile parts with qualities that differ in the longitudinal direction resides above all in the use of continuous roller profiling, with its characteristic advantages in terms of production costs and product quality.

Until now, profiles with different materials or material qualities in the longitudinal direction could be produced only from tailored blanks, which because of their limited component length cannot be put into an appropriate form by means of roller profiling.

A further independent aspect of the invention relates to a profile part of metal, in particular for vehicle bodies, having at least two portions which are profiled at least in some regions in the transverse direction, and the at least two portions of the profile part are joined together adjacent one another in the transverse direction of the profile, and the profile part can be produced by shaping, in particular by roller profiling, of a metal strip according to the invention that can be wound up into a coil.

In a further embodiment, the at least two portions of the profile part comprise different materials or different types of material, so that the profile part has portions of different material properties and qualities in the longitudinal and profile direction. Thus the profile parts can be configured to suit the most various requirements in terms of quality and load requirements, using cost-saving shaping processes, such as roller profiling.

Further objects, advantages, characteristics, as well as advantageous effects of the present invention will become apparent from the ensuing description of the exemplary embodiments in conjunction with the drawings. All the characteristics described and/or shown in drawings, on their own or in arbitrary appropriate combination, form the subject of the present invention, even independently of their summary in the claims or the claims dependency.

### BRIEF DESCRIPTION OF THE DRAWINGS

Shown are:

FIG. 1, a first exemplary embodiment of a metal strip, which can be wound up into a coil and has two portions;

FIG. 2, a further exemplary embodiment of a metal strip that can be wound up, having three different, periodically disposed portions;

FIG. 3, a profile part which can be produced from a metal strip according to FIG. 1;

FIG. 4, a profile part which can be produced from a metal strip according to FIG. 2;

FIG. 5, a further exemplary embodiment of a metal strip, with three portions adjacent one another regionally in the longitudinal direction; and

FIG. 6, a profile part which can be made from a metal strip according to FIG. 5.

### DETAILED DESCRIPTION OF THE INVENTION

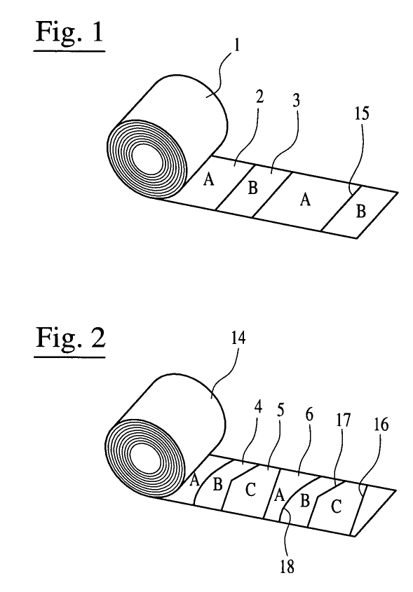

FIG. 1 shows a perspective view of a flat bar strip 1 which can be wound up into a coil and which in the longitudinal direction has different joined-together portions 2, 3. These portions 2, 3 are joined together adjacent one another essentially in the transverse direction of the strip. To that end, thermal joining methods, such as welding and in particular laser welding, are contemplated. The joining and weld seam 15 between the individual portions 2, 3 of the flat bar strip 1 extends here essentially in the transverse direction of the metal strip 1.

The geometry of the individual joined-together portions 2, 3 and their material is adapted to the particular load profile and the particular load requirements of the components to be made from the metal strip 1. For the portions 2, 3, steel, aluminum, as well as alloys that have steel and/or aluminum, and different types of steel and/or aluminum can be used.

Not only can the choice of material differ for the various portions 2, 3, but their material thickness and surface quality in particular can also differ.

The longitudinally varying load profiles and requirements for the components to be made from the metal strip 1 can therefore be met flexibly and effectively on the one hand by means of a suitable choice of materials and on the other by their different geometric design.

In FIG. 2, a further metal strip wound up into a coil 14 is shown, which has a total of three different joined-together portions 4, 5, 6, joined together adjacent one another essentially in the transverse direction of the strip. The individual portions 4, 5, 6, each comprising different materials or types of material and each having different platelike dimensions, are disposed here, as also already shown in FIG. 1, periodically in the longitudinal direction of the metal strip 14.

In contrast to the exemplary embodiment of FIG. 1, the connecting seams 16, 17, 18 between the portions 6 and 5 and between the portions 4 and 6, extend not perpendicular to the longitudinal direction of the metal strip but transversely and in different designs. While the connecting seam 16 between the portions 5 and 6 extends rectilinearly and transversely to the longitudinal direction of the metal strip, the joining seam 17 located between the portions 4 and 5 has a bend approximately in the middle of the metal strip. The further joining seam 18, which is formed between the portions 4 and 6, extends in slightly curved fashion in the plane of the metal strip 14.

Regardless of how the individual joining or weld seams 16, 17, 18 formed between the portions extend, it is always nevertheless provided that the individual portions 4, 5, 6 have a geometry that is complementary and adapted to their adjacently disposed portions, so that the metal strip is essentially filled over its full surface by the different portions 4, 5, 6.

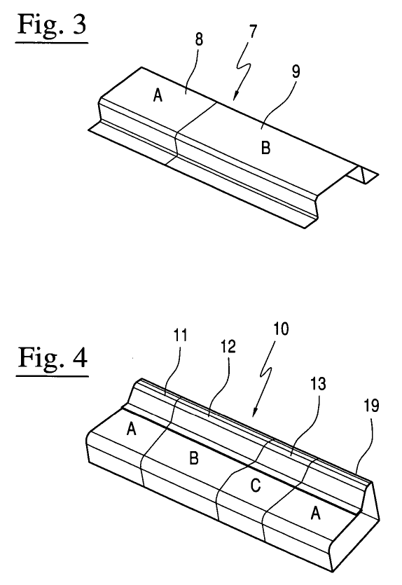

FIG. 3 shows a perspective view of a profile part 7, which can be made from a metal strip 1 according to FIG. 1. The portions 8 and 9 of the profile part 7, of different lengths and adjoining one another in the transverse direction, here correspond substantially to the portions 2 and 3 of the metal strip shown in FIG. 1. The profile part 7 shown in FIG. 3 can be shaped in particular by roller profiling of the metal strip 1 shown in FIG. 1 and, once the shaping process is completed, can be cut to length to suit the periodicity of the metal strip 1.

As a result, it becomes possible in particular to create profile parts 7, with different materials or material qualities in the longitudinal direction, by means of roller profiling. The advantages of such a production method based on roller profiling for such profiled sheet-metal parts are in particular reduced production effort and lower production costs.

FIG. 4 shows a further profile part 10, which can be made by shaping from a metal strip 14 shown in FIG. 2 and which has different portions 11, 12, 13. The individual portions 11, 12, 13 of the profile part 10 are similar to the portions 6, 4, 5 of the metal strip 14 shown in FIG. 2. It can be seen clearly that the individual weld seams between the portions 11, 12, 13 sometimes extend rectilinearly only in some regions and furthermore transversely to the longitudinal direction of the profile part 10.

The profile part 10 shown in FIG. 4 in this view is not cut to length strictly to suit its periodicity of the various portions 11, 12, 13. For instance, this part 10 has two portions 11 and 19 which are manufactured from the same material or the same type of material. Depending on the requirements made of the profile 10, it can certainly be provided that cutting a profiled metal strip 14 to length be done not in the region of a seam between individual portions 16, 17, 18, but rather in the middle through one of the portions 4, 5, 6. In this way, a seam 16, 17, 18 extending in the longitudinal direction of the metal strip is prevented from being severed when a shaped profile part 10 is being cut to length. Moreover, it is attained as a result that profile parts 10 with four different portions 11, 12, 13, 19 can be made from a metal strip 14 that has only three different portions 4, 5, 6.

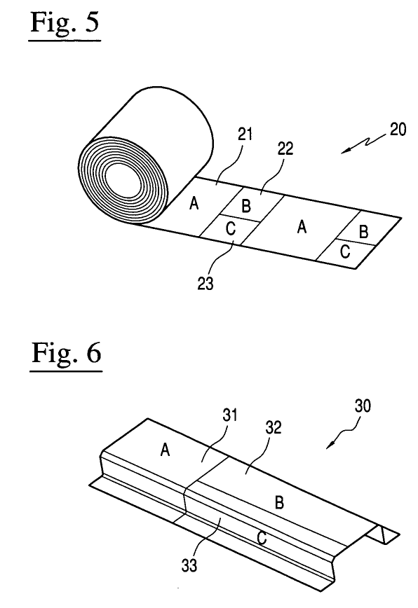

FIG. 5 shows a further exemplary embodiment of a metal strip 20, which can be wound into a coil and which has three portions 21, 22, 23. These portions, similarly to the exemplary embodiments described above, have different material qualities, such as different material thicknesses, or comprise different materials.

In the embodiment of FIG. 5, both the portion 22 and the portion 23 are joined to the portion 21 and adjacent to it, in the transverse direction of the strip. The two portions 22, 23 themselves, however, do not extend over the full width of the metal strip 20 and are therefore located side by side in the transverse direction of the strip, and consequently are welded together adjacent one another in the longitudinal direction.

The metal strip 20 shown in FIG. 5 has a kind of patchwork pattern as an example. The individual portions 21, 22, 23 each have a rectangular or even square basic geometry. Still other embodiments are conceivable in which the individual portions 21, 22, 23 have a more-complex polygonal geometry and together add up to filling the full surface of the metal strip 20. In particular, it is also conceivable for an individual portion to be adjacent regionally or completely in both the transverse direction and the longitudinal direction of the strip to a single portion or to a plurality of different portions.

FIG. 6, finally, is a perspective view of a profile part 30 which can made by a shaping process, such as roller profiling, from the metal strip 20 shown in FIG. 5. The portion 31 of the profile part 30 corresponds here to the portion 21 of the metal strip 20; portion 32 corresponds to portion 22; and portion 33 of the profile part 30 corresponds to the portion 23 of the metal strip shown in FIG. 5.

In the exemplary embodiment shown in FIGS. 5 and 6, the invention is not essentially limited to joined-together portions adjacent one another in the transverse direction of the strip but instead furthermore includes arrangements of arbitrarily dimensioned portions with different geometries.

### LIST OF REFERENCE NUMERALS

1 Metal strip/coil
2 Portion
3 Portion
4 Portion
5 Portion
6 Portion
7 Profile part
8 Portion
9 Portion
10 Profile part
11 Portion
12 Portion
13 Portion
14 Metal strip/coil
15 Weld seam
16 Weld seam
17 Weld seam
18 Weld seam
19 Portion
20 Metal strip
21 Portion
22 Portion
23 Portion
30 Metal strip
31 Portion
32 Portion
33 Portion

1. A metal strip for being wound into a coil (1; 14), having at least two joined-together portions (2, 3; 4, 5, 6), characterized in that the portions (2, 3; 4, 5, 6) are joined together adjacent one another essentially in the transverse direction of the strip (1; 14).

2. The metal strip as defined by claim 1, characterized in that the at least two portions (2, 3; 4, 5, 6) comprise different materials or different types of material.

3. The metal strip as defined by claim 1, characterized in that the portions (2, 3; 4, 5, 6) comprise steel or aluminum and/or alloys that have steel or aluminum.

4. The metal strip as defined by claim 1, characterized in that the portions (2, 3; 4, 5, 6) have different material thicknesses.

5. The metal strip as defined by claim 1, characterized in that the width of the portions (2, 3; 4, 5, 6) is essentially equivalent to the transverse extent of the strip (1; 14).

6. The metal strip as defined by claim 1, characterized in that the length of at least one of the portions (2, 3; 4, 5, 6) is greater than its width.

7. The metal strip as defined by claim 1, characterized in that the at least two portions (2, 3; 4, 5, 6) are disposed periodically in the longitudinal direction of the strip (1; 14).

8. The metal strip as defined by claim 1, characterized in that the at least two portions (2, 3; 4, 5, 6) are butt-jointed and/or are joined together by means of a thermal joining process.

9. The metal strip as defined by claim 1, characterized in that the at least two joined-together portions (2, 3; 4, 5, 6) are welded together.

10. The metal strip as defined by claim 1, characterized in that a seam (15; 16, 17, 18) between the at least two portions (2, 3; 4, 5, 6) extends continuously between both side edges of the strip (1: 14).

11. The metal strip as defined by claim 10, characterized in that the seam (15; 16, 17, 18) between the at least two portions (2, 3; 4, 5, 6) in at least some regions is rectilinear and/or curved and/or bent.

12. The metal strip as defined by claim 1, characterized in that the at least two portions (2, 3; 4, 5, 6), for substantially filling the strip (1; 14) over the full surface, have arbitrary, complementary geometries.

13. The metal strip as defined by claim 12, characterized in that an at least third portion (23) is provided, which is joined to at least one of the at least two portions (21, 22), adjacent one another, in at least some regions essentially in the longitudinal direction and in the transverse direction of the strip (20).

14. A method for producing profiles (7; 10), in particular for vehicle bodies, characterized by an at least regional shaping of a metal strip (1; 14) as defined by claim 1, transversely to the longitudinal direction of the metal strip (1; 14).

15. The method as defined by claim 14, characterized in that the at least regional shaping of the metal strip (1; 14) is effected by means of roller profiling and/or deep drawing and/or stretcher-forming.

16. The method as defined by claim 15, characterized in that the manufacture of the metal strip (1; 14) and the ensuing shaping are combined in one production line.

17. The method as defined by claim 14, characterized in that the metal strip (1; 14) is delivered in the form of a wound-up coil to a shaping apparatus.

18. The method as defined by claim 14, characterized in that the shaped metal strip is cut to length to suit a periodicity of the portions joined together in the longitudinal direction.

19. A metal profile part, in particular for vehicle bodies, having at least two portions (2, 3; 4, 5, 6) which are joined together, adjacent one another, in the transverse direction of the profile (7; 10), characterized in that for its production, shaping and in particular roller profiling of a metal strip (1; 14) as defined by claim 1 is provided.
